(19) United States
(12) Patent Application Publication
(10) Pub. No.: US 2015/0146114 A1
(43) Pub. Date: May 28, 2015

(54) Vehicle Display Mount

(71) Applicant: Jeffery Williams, Lexington, SC (US)

(72) Inventor: Jeffery Williams, Lexington, SC (US)

(21) Appl. No.: 14/556,040

(22) Filed: Nov. 28, 2014

Related U.S. Application Data
(60) Provisional application No. 61/909,402, filed on Nov. 27, 2013.

(51) Int. Cl. H04N 5/655; B60R 11/02

(52) U.S. Cl. CPC H04N 5/655; B60R 11/0229; B60R 2011/0085
USPC 348/837

(57) ABSTRACT

The present invention is an attachment that is designed to mount a flat screen display to a bumper of a vehicle. The present invention includes a substantially L-shaped tubular brace having a vertically-oriented mounting end and a horizontally-oriented attachment end. The vertically-oriented mounting end includes a concentric sleeve that has a bracket that removably attaches to a display. The concentric sleeve allows a display to swivel and be viewed at a variety of angles. The horizontally-oriented attachment end is removably secured to a vehicle bumper, such as a conventional square channel bumper, by removably inserting the horizontally-oriented attachment in the hollow channel of the bumper. The attachment end includes a pair of square-shaped flanges that are spaced apart along the length of the attachment end and are sized to be received within the hollow channel of the bumper. The flanges support the weight of the assembly and an attached display.

### CROSS REFERENCE TO RELATED APPLICATION

This application claims the benefit of U.S. Provisional Application No. 61/909,402 filed on Nov. 27, 2013. The above identified patent application is herein incorporated by reference in its entirety to provide continuity of disclosure.

### BACKGROUND OF THE INVENTION

1. Field of the Invention

The present invention relates to bumper attachments to vehicle. More specifically, the present invention pertains to an improved display attachment that is mounted to the bumper of a vehicle that allows for a flat screen display or television to be mounted thereon for outside viewing. The present invention includes a substantially L-shaped brace having a vertically-oriented mounted end for mounting the display thereon, and a horizontally-oriented attachment end for removable attachment to a vehicle bumper.

One of the biggest pregame activities to football is tailgating. A tailgate party is a social event usually occurring in parking lots at stadiums and arenas before and occasional after games. Tailgating, prior to sporting events, has long been a tradition in the professional sports and collegiate sports. Tailgating festivities are a great way to bring friends, family, classmates, and alumni together for a fun, safe and secure experience.

Some tailgaters do not let the weather spoil their fun. Some diehard fans will even drive a recreational vehicle (vehicle) to a game and have the convenience of a mobile home to enjoy the game at the stadium. Other diehard fans even keep the tailgate party going despite not even having tickets to the game. Especially in areas of with strong and proud fan bases, tickets are hard to come by. However, as tailgating is such a large tradition in sports, ticketless fans still go to the stadium parking lots to partake in the festivities. Therefore, it does not require a lot of imagination to know that preparations are extensive and often extravagant.

Like many social traditions, tailgating continues to evolve to include more and more. One example is satellite television broadcasting so that tailgaters can watch the pre-game show from the parking lot or even the entirety of the game from the parking lot. Often tailgaters will set up a television (TV) atop a folding table or place it in the back of a flatbed truck. These TVs can then be connected to a satellite dish and receiver. However, placing a TV on a folding table or other methods can lead to awkward viewing. Therefore, there is a need for mounting a TV during tailgating or other events for comfortable viewing.

The present invention provides an undemanding and convenient solution to mounting a display to a vehicle for easy and comfortable viewing. The present invention attaches a display, such as a flat screen TV to the a vehicle bumper, which allows for TV viewing outside whether it is during tailgating, camping, hunting, or any other recreational activities. The present invention includes a substantially L-shaped brace having a vertically-oriented mounting end integrally formed with a horizontally-oriented attachment end. The horizontally-oriented attachment end is removably inserted into the hollow channel of a vehicle bumper and comprises a pair of spaced apart flanges that secure the attachment end therein. The mounting end comprises a concentric sleeve with a bracket that is utilized to removably mount a TV thereon. The concentric sleeve allows the TV to be viewed from multiple angles.

2. Description of the Prior Art

Devices have been disclosed in the prior art that relate to attachments to vehicles. These include devices that have been patented and published in patent application publications. Some of these devices disclose an attachment to a vehicle that is used to carry articles or equipment. Other devices disclose an attachment for a vehicle that mounts a portable satellite TV system. These devices, however, do not disclose an attachment that mounts a display to a bumper of a vehicle. The vehicle display mount includes an L-shaped brace having a horizontally-oriented attachment end that removably attaches to a vehicle rear bumper and a vertically-oriented mounting end that pivotably mounts a display, such as a flat screen TV. The foregoing is a list of devices deemed most relevant to the present disclosure, which are herein described for the purposes of highlighting and differentiating the unique aspects of the present invention, and further highlighting the drawbacks existing in the prior art.

Specifically, Published U.S. Patent Application Number 2007/0247378 to Masterson discloses a device for mounting a dish satellite antenna onto a recreational vehicle. The Masterson device discloses a front bracket, a rear bumper bracket, a swing arm extension and a satellite mounting pole. The rear bumper bracket is a flat metal plate, with a metal cylinder welded to the center, designed to mount to the rear bumper of a RV. The front bracket is a U-shaped metal piece designed to slip over the travel trailer tongue with a metal cylinder welded to the metal piece. The swing arm extension can be inserted into the metal cylinder of either the front bracket or rear bracket. The satellite mounting pole is a tube with a lower end attached to the swing arm extension and upper end inserted to the base of a satellite dish antenna. The Masterson device relates to mounting a dish satellite antenna onto a RV, and does not disclose a device that is related to mounting a display on a vehicle.

Similarly, U.S. Patent Number 2005/146483 to Levasseur discloses a vehicle-mounted satellite dish antenna support system. The Levasseur device is attached to the trailer hitch of an automobile. The Levasseur device discloses a base support member and at least one vertical support member extending upward from the base support member. The vertical support member is capable of engaging a satellite dish antenna. The Levasseur device does not disclose a device that is related to mounting a display on a vehicle.

Published U.S. Pat. No. 5,845,832 to Truckor discloses a shelf bracket for a wall mount for a flat screen television. The Truckor device includes a connecting member with a main body secured to the wall mount and a support member coupled to the connecting member. The support member is substantially L-shaped to support a shelf thereon. However, the Truckor device does not disclose a device that is related to mounting a display on a vehicle.

U.S. Pat. No. 5,845,832 to Eichmann discloses a rear-mounted vehicle cargo carrier. The Eichmann device includes a mounting bar for detachable mounting on a vehicle, a first arm pivotally mounted on the mounting bar, and a second arm that is pivotally carried by the first arm. The Eichmann device further discloses a frame bar pivotally carried by the second arm. The frame bar is utilized to carry cargo. However, the Eichmann device discloses a cargo carrier mounted on a vehicle and does not disclose a device that is related to mounting a display on a vehicle.

U.S. Pat. No. 5,518,159 to Deguevara discloses an article carrier that is detachably attached to a truck. The Deguevara device discloses a connecting member that is telescopically received within a tubular hitch affixed to the vehicle. The Deguevara device further discloses a fixed arm connected to the connecting member which extends substantially perpendicularly thereto. A movable arm is also connected to the fixed arm and disposed in a co-plane with fixed arm to allow for maneuverability within that plane. A column is connected to the movable arm and thereon is a means for supporting the article to be carried. The Deguevara device however does not disclose an attachment for mounting a display on a vehicle.

U.S. Pat. No. 7,631,791 to Allen discloses a swing-out hitch mounted equipment carrier that is detachably mounted to a vehicle that is movable into a collapsed position and an extend position. The Allen device has a securing means for securing the device to a vehicle. A fixed arm is attached to the securing means and a swing arm is pivotally attached to the fixed arm. An upright member is connected to an end of the swing arm and further includes an equipment carrier attached thereto. However, the Allen device does not disclose a device that relates to mounting a display to a vehicle.

Finally, U.S. Pat. No. 6,386,401 to Dusen is a carrier rack attachable to vehicles. The Dusen device discloses a base arm having a pivot end and a mounting end for removable mounting to a vehicle. A swing arm is connected to the pivot end and also pivotally connected to a vertical article carrier arm. The Dusen device is designed to pivot downwards and upwards to lower and raise articles. However, the Dusen device discloses a carrier rack and does not disclose a device that relates to mounting a display to a vehicle.

The devices disclosed in the prior art have several known drawbacks. Some of these devices disclose an attachment to a vehicle that is utilized to carry articles or equipment. Other devices disclose an attachment for an RV that mounts a portable satellite TV system. These devices, however are limited to carrying equipment or mounting a portable satellite TV system. The present invention overcomes these limitations by disclosing a device that relates to mounting a display, such as a flat screen TV to a bumper of a vehicle.

The present invention includes a substantially L-shaped brace having a vertically-oriented mounting end and a horizontally-oriented attachment end. The vertically-oriented mounting end comprises a concentric cylindrical sleeve with a closed side and an open side that forms a recess. The recess receives an end of the mounting end therethrough to removably secure the cylindrical sleeve to the mounting end. The sleeve further comprises a mounting bracket that removably attaches a display. The horizontally-oriented attachment end is removably secured in the hollow channel of a square channel bumper and includes a pair of spaced apart flanges. The flanges support the weight of the brace and prevent the attachment end from loosening unintentionally. It is therefore submitted that the present invention is substantially divergent in design elements from the prior art, and consequently it is clear that there is a need in the art for an improvement to vehicle display mounts. In this regard, the instant invention substantially fulfills these needs.

### SUMMARY OF THE INVENTION

In view of the foregoing disadvantages inherent in the known types of vehicle bumper attachments for equipment storage and satellite dishes now present in the prior art, the present invention provides a new and improved vehicle display mount that mounts a display to a bumper of a vehicle.

It is therefore an object of the invention to provide a new and improved vehicle display mount that has all of the advantages of the prior art and none of the disadvantages.

An object of the present invention is to provide a new and improved vehicle display mount that removably mounts a display to the rear bumper of a vehicle.

Another object of the present invention is to provide a new and improved vehicle display mount that comprises a substantially L-shaped brace having a horizontally-oriented attaching end, a vertically-oriented mounting end, a pair of spaced part flanges integrally formed with the horizontally-oriented attaching end, and a concentric sleeve having a bracket for pivotally mounting a flat screen TV to the vertically-oriented mounting end.

Yet another object of the present invention is to provide a new and improved vehicle display mount that is removably inserted into the hollow interior of a vehicle bumper.

Still yet another object of the present invention is to provide a new and improved vehicle display mount that utilizes the flanges to removably secure the brace to the vehicle bumper.

Yet another object of the present invention is to provide a new and improved vehicle display mount that is easy to install and convenient to use.

Still yet another object of the present invention is to provide a new and improved vehicle display mount wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows an overhead perspective view of the present invention.

FIG. 2 shows a frontal view of the present invention as removably attached to the rear bumper of a vehicle.

FIG. 3 shows a view of the vertically-oriented mounting end of the present invention, supporting a flat screen TV from the rear surface thereof.

FIG. 4 shows a cross section of the horizontally-oriented attachment end as removably secured to a square tube bumper of a vehicle.

FIG. 5 shows a side perspective of an alternate embodiment of the attachment end in connection with a vehicle bumper, which pivotally attaches to the bumper.

FIG. 6 shows a view of the alternate embodiment in a retracted configuration.

### DETAILED DESCRIPTION OF THE INVENTION

References are made herein to the attached drawings. Like reference numerals are used throughout the drawings to depict like or similar elements of the vehicle display mount. For the purposes of presenting a brief and clear description of the present invention, the preferred embodiment will be discussed as attached to a rear bumper of a vehicle. The figures are intended for representative purposes only and should not be considered to be limiting in any respect.

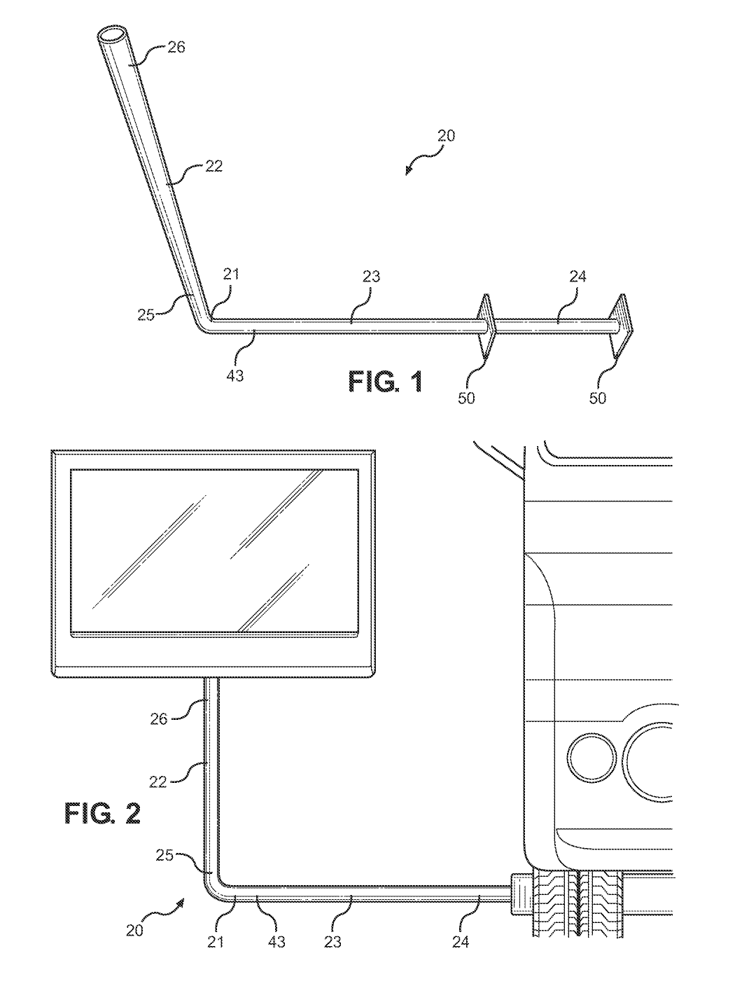

Referring now to FIGS. 1 and 2, there are shown views of the preferred embodiment of the vehicle display mount 20 of the present invention, which is removably attached to the rear bumper of a vehicle. The vehicle display mount 20 comprises a tubular brace 21 substantially L-shaped. The brace 21 comprises a vertically-oriented mounting end 22 and a horizontally-oriented attachment end 23. The horizontally-oriented attachment end 23 comprises a distal end 43 and a proximal end 24, whereas the vertically-oriented mounting end 22 comprises a first end 25 and a second end 26.

The proximal end 24 is removably attached to the rear bumper of a vehicle by removably inserting the proximal end in the hollow channel of the bumper. The proximal end 24 comprises a pair of spaced apart flanges 50 integrally formed with the proximal end 24. The flanges 50 are substantially square-shaped and spaced apart along the length of the attachment end. The flanges are sized to be received within the hollow channel of the rear bumper of a vehicle. The distal end 43 is integrally formed with the first end 25 of the vertically-oriented mounting end 22. The second end 26 is utilized to removably attach a display, such as a flat screen TV. The brace 21, in the illustrated embodiment, is constructed from steel, however, in other embodiments, the brace 21 is composed of other suitable steels or metals, such as carbon steel and stainless steel.

In some embodiments, distal end 43 further comprises a T-shaped channel preferably with a square cross section. The end extending away from the two aligning ends is telescopically received relative to the distal end 43 to provide horizontal extension adjustment. The first end 25 of the vertically-oriented mounting end 22 is telescopically received relative to the aligning pair of ends of the channel to provide vertical height adjustment. The channel further includes adjusters configured to removably secure the channel relative to the distal end 43 and the first end 25, respectively, to the desired horizontal extension and vertical height. The adjuster comprises a retaining bolt and a plurality of apertures provided on the channel, distal end 43, and the first end 25. The apertures are configured to align at selected height-adjustable locations and further configured to receive the bolt therein to affix telescopic position.

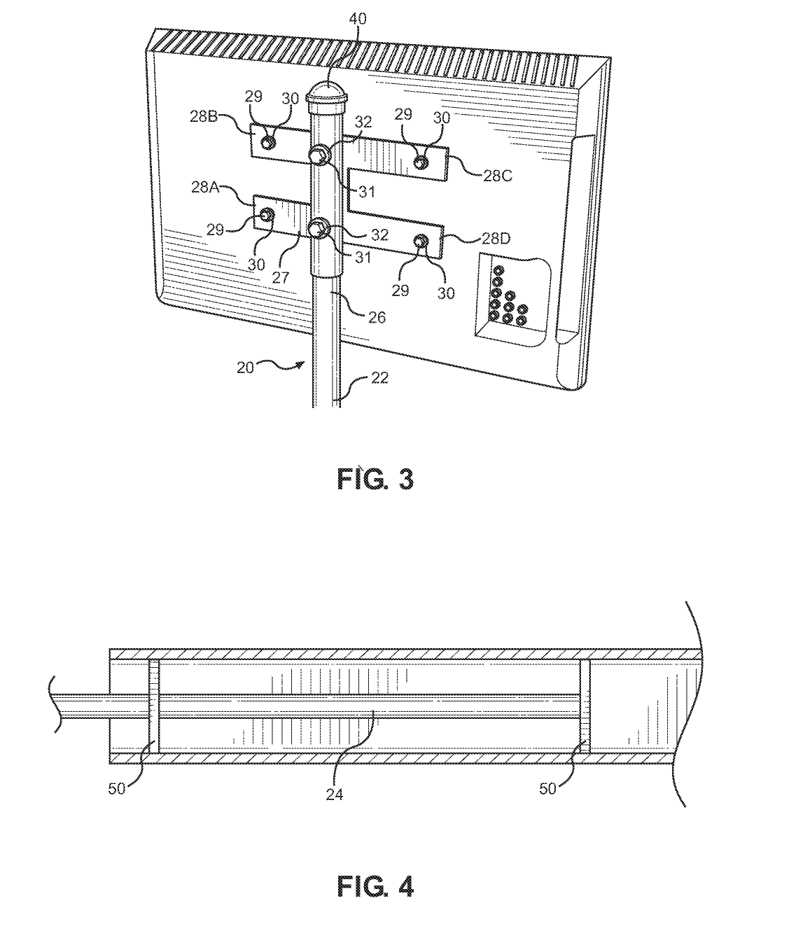

Referring now to FIG. 3, there is shown a view of the vertically-oriented mounting end 22 of the vehicle display mount 20 supporting a flat screen TV from the rear surface thereof. The second end 26 comprises a removably attached cylindrical sleeve 40. The sleeve 40 includes a closed side 41 and an open side 42 that forms a recess therethrough. The recess is configured to removably receive the second end 26 therethrough. The sleeve 40 is concentric with the second end 26 of the vertically-oriented mounting end 22, which allows sleeve 40 to swivel and be pivotally attached thereon.

The sleeve 40 further comprises a display mounting bracket 27. The bracket 27 is substantially I-shaped and comprising two or more corners 28A, 28B, 28C, 28D disposed along opposite sides of the bracket 27. The bracket 27 is configured to removably support a flat screen TV. The corners 28A, 28B, 28C, 28D of the bracket 27 comprises male threaded elements 29 that align with female threaded elements 30 on the backside of a flat screen TV. To removably mount the bracket 27 to the backside of a flat screen TV, the bracket 27 is placed flush to substantially the center of the backside of a flat screen TV aligning male threaded elements 29 to female threaded elements 30. The size of bracket 27 is configured to the size of the flat screen TV. Larger embodiments with larger brackets 27 are designed for supporting larger flat screen TVs, whereas smaller brackets 27 are designed for supporting smaller flat screen TVs.

The second end 26 also comprises a plurality of male and female threaded elements 31, 32 in a linear configuration that are utilized to removably attach the sleeve 40 to the second end 26 of the vertically-oriented mounting end 22. In this manner, sleeve 40 allows a flat screen TV to be pivotally mounted thereon, and permits a flat screen TV to be viewed from multiple angles. The bracket 27 with a flat screen TV mounted thereon can be removed from the second end 26 by unfastening the male and female threaded elements 31, 32 for safekeeping during driving. The bracket 27 can then be reattached when the vehicle is stationary.

Referring now to FIG. 4, there is shown a cross section of the vehicle rear bumper with the vehicle display mount 20 removably attached. A conventional vehicle rear bumper is a square channel bumper enclosing a hollow channel of the same shape. The proximal end 24 is removably inserted therethrough the hollow channel with both flanges 50 inserted therethrough. The flanges 50 support the weight of the assembly and an attached display. The flanges further prevent any rattling or loosening that may unsecure proximal end 24 unintendedly. Further, for safekeeping or portability, the proximal end 24 can be unsecured by pulling the proximal end away from the vehicle rear bumper. The vehicle display mount 20 can be easily reattached through the vehicle rear bumper on the next occasion the vehicle is stationary.

Those skilled in the art will recognize, or be able to ascertain using no more than routine experimentation, the distance and range between the flanges 50 for optimal securing of vehicle display mount 20. Those of ordinary skill in the art will also readily envision a variety of other locations within a distance and range, or substantially equivalent thereto, in which the flanges removably secure vehicle display mount 20 to a vehicle rear bumper. It is not desired to limit the exact distance between the flanges 50. Rather it is desired to disclose and claim functional flanges 50 that is utilized to removably secure the proximal end 24 through the hollow interior of a vehicle rear bumper. These modifications and variations are deemed to be within the scope of the inventive embodiments described herein.

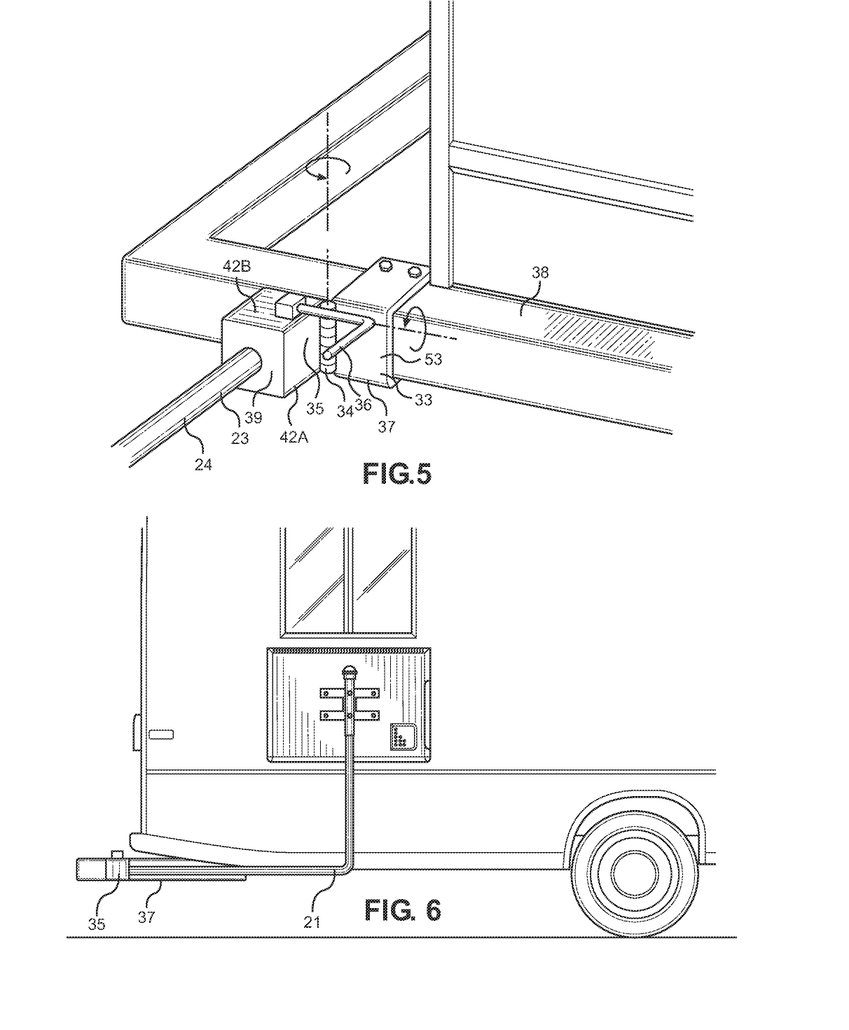

Referring now to FIGS. 5 and 6, there are shown side perspectives of another embodiment of the vehicle display mount 2. The proximal end 24 is pivotally attached to the rear bumper of a vehicle, such as an RV. The proximal end 24 comprises a vehicle bumper hitch 33 and a prism 35. The vehicle bumper hitch 33 comprises a hinge 34 and a clamp 37. Clamp 37 is substantially C-shaped having a coextensive interior (not annotated) and exterior surface 51. In this embodiment, the clamp 37 is removably secured to a square channel rear bumper 38 of a vehicle, whereby the interior surface is placed flush against the top, side and bottom of rear bumper 38. Clamp 37 further comprises male and female threaded elements that removably secure the clamp 37 to the remaining inner surface of the square channel rear bumper 38 that the clamp 37 attached thereon did not touch. However, various types of vehicles have different shapes and forms of rear bumpers 38. Other embodiments of the vehicle display mount 20 comprise appropriate clamps 37 that attach thereon different shapes of rear bumpers 38.

The proximal end 24 further comprises a prism 35 that is integrally formed with the proximal end 24. The prism 35 is rectangular prism in shape having opposing faces 39, inner and outer sides 42A, and top and bottom siders 42B. The horizontally-oriented attachment end 23 is tubular in shape and is welded substantially in the center of face 39 of the prism 35. The prism 35 is pivotally hinged by inner edge 40 on inner side 42A by a hinge 34. The hinge 34 is attached to the edge on the exterior surface 51 of the clamp 37. Hinge 34 is utilized to allow vehicle display mount 20 to move from a retracted configuration to an extended configuration. In the retracted configuration, as illustrated in FIG. 6, inner side 42A is placed flush to the exterior surface 51 of clamp 37, thereby allowing the brace 21 to be co-planar with the passenger side of the vehicle. The prism 35 is composed of the same steel material as the brace 21. In other embodiments, the prism 35 is composed of other suitable steels or metals, such as carbon steel and stainless steel.

While in the extended configuration as illustrated in FIG. 1, the inner side 42A is substantially perpendicular to exterior surface 43 of clamp 37, thereby allowing the brace 21 to be substantially perpendicular to passenger side of the vehicle. Hinge 34 is designed to allow brace 21 to freely move between the extended and retracted configuration and users may place brace 21 in between the two configurations if so desired. In the preferred embodiment, the hinge 34 is a continuous hinge, however in other embodiments, a piano hinge or butt hinge or other suitable hinges are used in substitute of continuous hinge 34.

Further, the proximal end 24 comprises a safety lock 36. The lock 35 is substantially L-shaped and attached to side 42B of prism 35. While inner side 42A is placed flush against the exterior surface 43 in the retracted configuration, lock 35 can rotate downwards trapping prism 35 flush to the rear bumper 38. Safety lock 35 is allows the vehicle display mount 20 to be locked in place while driving without any fear of the vehicle display mount 20 being released from the retracted configuration into an extended configuration while driving. To unlock prism 35 from the vehicle rear bumper 38 while the vehicle is stationary, lock 35 is rotated upwards thereby allowing free movement of the vehicle display mount 20. Lock 35 is composed of stainless steel, however, in other embodiments other appropriate metals such as steel or carbon steel are used in substitute of stainless steel.

In other embodiments, safety lock 36 comprise a slide bolt latch or other suitable fasteners that are utilized to lock the prism 35 to the rear bumper 38 of a vehicle. Further, the vehicle display mount 20 can also be dismounted and stored inside of the vehicle or elsewhere by unfastening clamp 37 from rear bumper 38. Vehicle display mount 20 can easily be reattached by reattaching clamp 37 to rear bumper 38.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle display mount, comprising:
a brace having a horizontally-oriented attachment end and a vertically-oriented mounting end;
said horizontally-oriented attachment end having a proximal end and a distal end;
said proximal end having a pair of spaced apart flanges;
said vertically-oriented mounting end having a first end and a second end;
said first end integrally formed with said distal end of said horizontally-oriented attachment end;
said second end supporting a cylindrical sleeve having a closed end and an open end forming a recess;
said cylindrical sleeve further having a display mounting bracket;
said horizontally-oriented attachment end and said vertically-oriented mounting end being substantially orthogonal to one another to form a substantial L-shape.

2) The vehicle display mount of claim 1, wherein said recess of said cylindrical sleeve is configured to removably receive said second end therethrough.

3) The vehicle display mount of claim 1, wherein said cylindrical sleeve is concentric with said second end, which allows said sleeve to swivel and pivot.

4) The vehicle display mount of claim 1, wherein said display mounting bracket is configured to removably support a flat screen television.

5) The vehicle display mount of claim 1, wherein:
said display mounting bracket is substantially I-shaped having two or more corners disposed along opposite sides of said display mounting bracket;
said corners having apertures to receive fasteners for securing said display to said display mounting bracket.

6) The vehicle display mount of claim 1, wherein said cylindrical sleeve is fastened to said second end using one or more fasteners.

7) The vehicle display mount of claim 1, wherein:
said proximal end and said flanges are sized to removably insert into a hollow interior of an open tube bumper of a vehicle.

8) The vehicle display mount of claim 1, wherein:
said distal end further comprises a T-shaped channel telescopically received relative to said distal end and for telescopically receiving said first end to provide height adjustment.

9) The vehicle display mount of claim 8, wherein:
wherein said channel further comprises an adjuster.

10) The vehicle display mount of claim 9, wherein:
said adjuster comprises a bolt and a plurality of apertures provided on said distal end, said channel and said first end, wherein said apertures are configured to be aligned at selected height-adjustable locations and further configured to receive said bolt therein to affix telescopic positioning.

11) A vehicle display mount, comprising:
a brace having a horizontally-oriented attachment end and a vertically-oriented mounting end;
said horizontally-oriented attachment end having a proximal end and a distal end;
said proximal end having a vehicle bumper hitch and a prism;
said hitch having a clamp, a hinge, and a safety lock;
said prism integrally formed with said proximal end and having opposing faces, inner and upper sides and top and bottom sides;
said clamp substantially C-shaped and having an interior and exterior surface to removably secure said clamp to said rear bumper;
said hinge utilized to hingedly attach an inner edge said face of said prism to the inner edge of said exterior surface of said clamp;
said vertically-oriented mounting end having a first end and a second end;
said first end integrally formed with said distal end of said horizontally-oriented attachment end;
said second end supporting a cylindrical sleeve having a closed end and an open end forming a recess;
said cylindrical sleeve further having a display mounting bracket;
said horizontally-oriented attachment end and said vertically-oriented mounting end being substantially orthogonal to one another to form a substantial L-shape.

12) The vehicle display mount of claim 11, wherein said recess of said cylindrical sleeve is configured to removably receive said second end therethrough.

13) The vehicle display mount of claim 11, wherein said cylindrical sleeve is concentric with said second end, which allows said sleeve to swivel and pivot.

14) The vehicle display mount of claim 11, wherein:
said display mounting bracket is substantially I-shaped having two or more corners disposed along opposite sides of said display mounting bracket;
said corners having apertures to receive fasteners for securing said display to said display mounting bracket.

15) The vehicle display mount of claim 11, wherein said cylindrical sleeve is fastened to said second end using one or more fasteners.

16) The vehicle display mount of claim 11, wherein:
said proximal end and said flanges are sized to removably insert into a hollow interior of an open tube bumper of a vehicle.

17) The vehicle display mount of claim 11, wherein:
said hinge is utilized to allow said brace to move from a retracted configuration to an extended configuration;
wherein a said inner side of said prism is flush to said exterior surface of said clamp in the retracted configuration;
wherein said brace is substantially co-planar to the passenger side of a vehicle in the retracted configuration;
wherein said inner side of said prism is substantially perpendicular to said exterior surface in the extended configuration.

18) The vehicle display mount of claim 11, wherein:
said hitch further comprising a safety lock;
wherein said safety lock is rotatably welded to the top side of said prism.

19) The vehicle display mount of claim 11, wherein:
said safety lock is substantially L-shaped;
wherein said safety lock is rotated downwards to temporarily secure said prism in retracted configuration and rotated upwards to release said prism from retracted configuration.

20) The vehicle display mount of claim 11, wherein said proximal end engages and integrally formed with the center of said face of said prism.
